(19) United States
(12) Patent Application Publication
(10) Pub. No.: US 2012/0059729 A1
(43) Pub. Date: Mar. 8, 2012

(54) LOCATION AWARE MOBILE MARKETPLACE APPLICATION AND SYSTEM

(75) Inventors: Humberto Enrique Roa, Bainbridge Island, WA (US); Kenji Hiroshi Kato, San Jose, CA (US); Sen Guan Wen, Bainbridge Island, WA (US); Carlos Sola-Llonch, Seattle, WA (US); Rohan Ramesh Singh, Seattle, WA (US); Shannon Meade Roa, Bainbridge Island, WA (US)

(73) Assignee: Project Fastlane, Inc., Bainbridge Island, WA (US)

(21) Appl. No.: 13/219,480

(22) Filed: Aug. 26, 2011

Related U.S. Application Data
(60) Provisional application No. 61/377,438, filed on Aug. 26, 2010.
(60) Provisional application No. 61/452,066, filed on Mar. 11, 2011.

(51) Int. Cl. G06Q 30/06

(52) U.S. Cl. 705/26.1

(57) ABSTRACT

A location aware mobile marketplace application and system is described, including techniques for fulfilling requests associated with a location aware mobile marketplace comprising obtaining a location of a client using client location data retrieved from the client, receiving a request associated with one or more items, each of the one or more items associated with a venue and being identified in a database, determining if the one or more items are available to be supplied in response to the request, and fulfilling the request after determining that the one or more items are available to be supplied.

### CROSS REFERENCE TO RELATED APPLICATIONS

This application is a U.S. non-provisional patent application that claims the benefit of U.S. Provisional Patent Application No. 61/377,438, filed Aug. 26, 2010, entitled “Location Aware Mobile Marketplace,” and U.S. Provisional Patent Application No. 61/452,066, filed Mar. 11, 2011, entitled “Gated and Automated Order Processing,” all of which are herein incorporated by reference for all purposes.

### FIELD

The present invention relates generally to software. More specifically, techniques related to a location aware mobile marketplace application and system are described.

### BACKGROUND

Consumers and vendors, alike, are using mobile capabilities more and more to browse, purchase, sell, and offer for sale, goods and services. On the one hand, consumers are using location aware mobile devices (e.g., mobile communication devices, tablet computers, etc.) to browse catalogs and menus and make purchases online or using mobile applications. On the other hand, vendors are mobilizing their stores and service shops. Conventional techniques for managing consumer access to vendors are often limited to providing consumers with access to a single vendor, or a static, predetermined group of vendors. There are numerous vendors that operate online stores or online ordering systems (e.g., Amazon.com®, Apple™, Chipotle™, etc.). Many of these same vendors also implement applications for mobile devices. However, these conventional web and mobile applications are not able to provide a location aware mobile marketplace customized for a consumer based on criteria such as a consumer's current location, a vendor's current location, a vendor's hours of operation, and so on. For example, if a consumer visits the Apple™ online store or mobile application, the consumer can access only products and services offered by Apple™. Likewise, when a consumer visits the Chipotle™ mobile application, the consumer can order only food, drink and merchandise from Chipotle™. For access to a variety of vendors, a consumer may visit the Amazon Marketplace through the Amazon.com® website or mobile application. However, the list of vendors available through the Amazon Marketplace is not tailored to criteria associated with a consumer's or vendor's mobility, such as the consumer's current location (e.g., whether the consumer's current location is several yards or thousands of miles from a vendor has no bearing on whether that vendor is made available to the consumer), the time of day during which the consumer or a vendor is at a location, a vendor's hours of operation, an event the consumer is currently attending, or any other criteria. This greatly limits the number and type of vendors that may sell to a consumer, as well as limiting the type of products and services that a consumer may purchase, through these conventional applications.

These conventional applications also are limited in their supply options to either a pick-up at a store location, or delivery to a physical address, and do not allow for delivery of items or services to a location that does not have a physical address, but that may otherwise be identified (e.g., a location in a sports stadium identified by a section, row and seat number). A consumer may request delivery of goods from Amazon.com® or Apple™ to their home or office address. A consumer also may pick up food from Chipotle™, or another restaurant, or have it delivered to their home or office. However, conventional applications do not allow for verification of, and delivery to, a consumer's current location outside of a physical address. This also greatly limits the number and type of vendors that may sell to a consumer, and the type of products and services that a consumer may purchase, using conventional applications.

Thus, what is needed is a location aware mobile marketplace application and system without the limitations of conventional techniques.

### BRIEF DESCRIPTION OF THE DRAWINGS

Various embodiments of the invention are disclosed in the following detailed description and the accompanying drawings:

FIG. 1 illustrates an exemplary system for implementing a location aware mobile marketplace;

FIG. 2 illustrates an exemplary architecture for a location aware mobile marketplace system;

FIG. 3 illustrates an exemplary architecture for a gated and automated order processing system implemented in a location aware mobile marketplace;

FIGS. 4A-4D illustrate exemplary architectures for components of a location aware mobile marketplace system;

FIG. 5 illustrates an exemplary process for fulfilling a client request in a location aware mobile marketplace;

FIG. 6 illustrates an exemplary process for fulfilling an order in a location aware mobile marketplace;

FIG. 7 illustrates an exemplary process for updating an order processing system in a location aware mobile marketplace;

FIG. 8 illustrates an exemplary wireframe of a screen for vendor selection;

FIG. 9 illustrates an exemplary wireframe of a screen showing vendor selection options on a map interface;

FIG. 10 illustrates an exemplary wireframe of a screen for entering location information;

FIG. 11 illustrates an exemplary wireframe of a screen for store selection;

FIG. 12 illustrates an exemplary wireframe of a screen for item category selection;

FIG. 13 illustrates an exemplary wireframe of a screen for item selection;

FIG. 14 illustrates an exemplary wireframe of a product screen;

FIG. 15 illustrates an exemplary wireframe of a screen displaying selected items and purchase options in a cart; and

FIG. 16 illustrates an exemplary computer system suitable for implementation of a location aware mobile marketplace.

### DETAILED DESCRIPTION

Various embodiments or examples may be implemented in numerous ways, including as a system, a process, an apparatus, a user interface, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

In some examples, the described techniques may be implemented as a computer program or application (“application”) or as a plug-in, module, or sub-component of another application. The described techniques may be implemented as software, hardware, firmware, circuitry, or a combination thereof for purposes of providing computational and processing capabilities. If implemented as software, the described techniques may be implemented using various types of programming, development, scripting, or formatting languages, frameworks, syntax, applications, protocols, objects, or techniques, including C, Objective C, C++, C#, Adobe® Integrated Runtime™ (Adobe® AIR™), ActionScript™, Flex™, Lingo™, Java™, Javascript™, JSON, Ruby, Rails, Ajax, Pert, COBOL, Fortran, ADA, XML, MXML, HTML, DHTML, XHTML, HTTP, XMPP and others. Also, if implemented as software, the described techniques may be implemented using a software development kit (SDK) or application programming interface (API). Design, publishing, and other types of applications, such as Dreamweaver®, Shockwave®, Flash®, and Fireworks®, may also be used to implement the described techniques. The described techniques may be varied and are not limited to the examples or descriptions provided.

A location aware marketplace allows a user to browse products and make purchases from a variety of vendors in a given geographic location. The given geographic location can either be pre-defined or generated. In some examples, a pre-defined location can be a mall, a sports arena, an amusement park, an airport, a particular gate in an airport, or other locations. In other examples, a location may be generated based on a user's current location, for example using a location aware device (e.g., a mobile communication device, laptop, etc.), for example, enabled with a global positioning system (GPS). In some examples, a list of available stores or vendors in or around the location (e.g., within a venue identified by a location aware device, within a certain distance from the user's current location, etc.) may be generated using the user's current location. The terms “store” and “vendor” are used interchangeably herein to refer to a person or entity providing goods or services. In other examples, a user might use criteria other than the user's current geographic location (e.g., the user might intend to be in a certain location in the future, the user may intend to make a purchase from a vendor that does not require geographic proximity, or the user may want to browse a catalogue). In still other examples, a gating functionality may be implemented to allow a vendor, or group of vendors, to control access to the ordering system, and the flow of incoming requests or orders, according to one or more criteria. As used herein, the term “request” may refer to any communication from a client device asking for a response of any kind (e.g., request for a list of available vendors, request for list of available items (e.g., a menu, a catalog, etc.), a request for the provision of a good or service (e.g., an order)). The gating of such requests may be conducted manually, semi-automatically, or automatically. The gating of such requests also may be implemented using static criteria (e.g., a pre-determined discount for an item for a fixed amount of time), dynamic criteria (e.g., a surcharge to be applied when inventory levels or order volumes meet a threshold), or both.

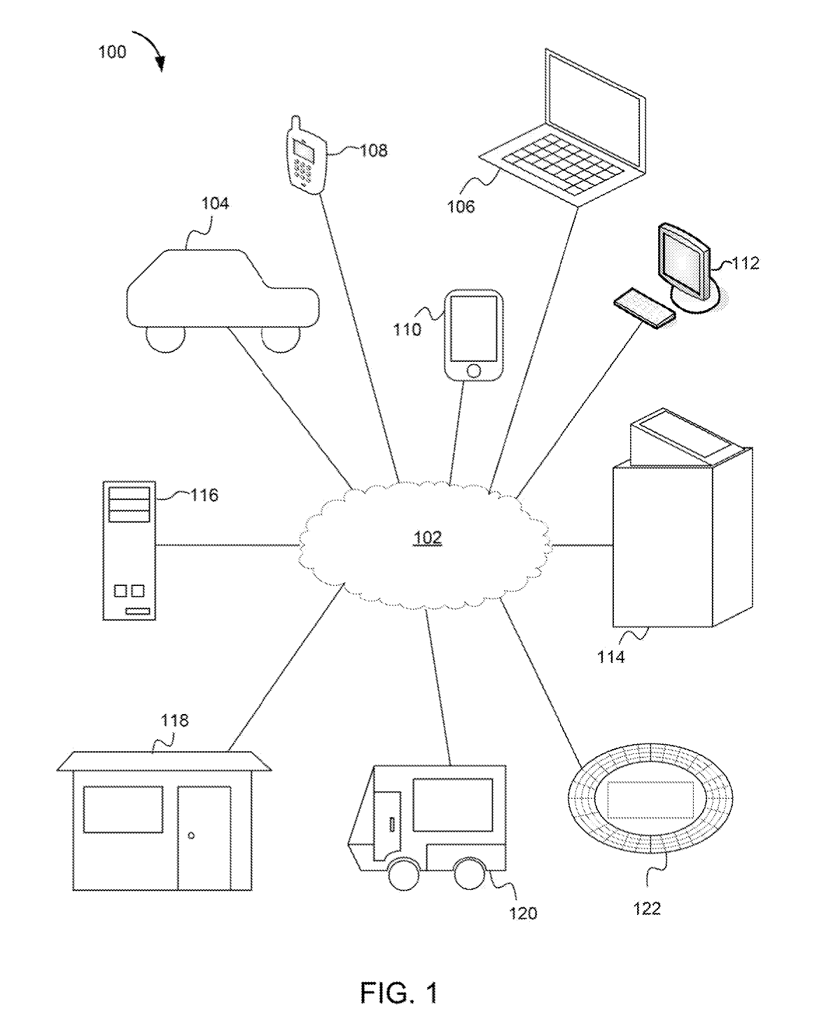

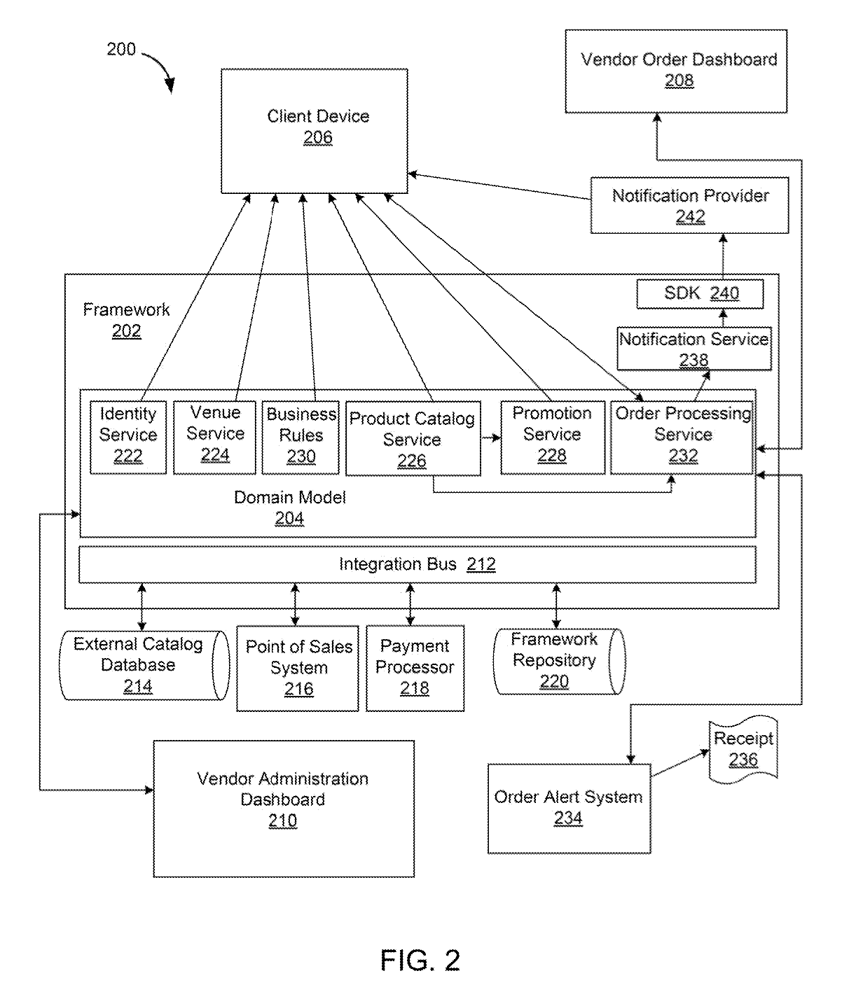

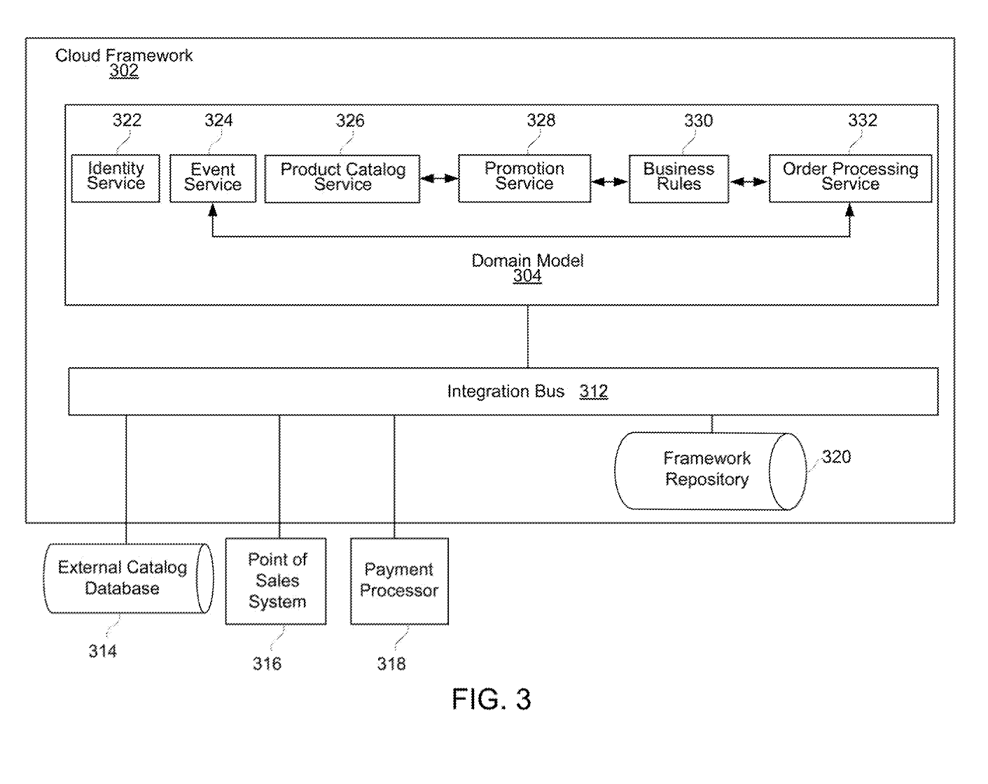

FIG. 1 illustrates an exemplary system for implementing a location aware mobile marketplace. In some examples, system 100 may include network 102, GPS-enabled vehicle 104, laptop 106, mobile communication device 108, tablet computer 110, computer 112, kiosk computer 114, server 116, store 118, mobile vendor 120 and venue 122. In some examples, network 102 may be cloud-based, and may be in communication with server 116. For example, network 102 may communicate with any of the other devices or locations shown, directly or indirectly. In other examples, location aware devices (e.g., GPS-enabled vehicle 104, laptop 106, mobile communication device 108, tablet computer 110, computer 112, kiosk computer 114, etc.) and vendors (e.g., store 118, mobile vendor 120 and venue 122), may communicate directly with server 116 (not shown), using either wired or wireless communication means. In some examples, a marketplace framework (e.g., shown in FIG. 2 and FIG. 3) may reside on server 116.

Location aware devices may include both mobile devices (e.g., laptop 106, mobile communication device 108 (e.g., iPhone®, Android® smartphone, etc.), tablet computer 110 (e.g., iPad®, HP TouchPad®, Microsoft® Tablet PC, etc.), etc.) and stationary devices with known locations (e.g., computer 112, kiosk computer 114, etc.). Vendors also may include both mobile vendors (e.g., mobile vendor 120, etc.) and stationary vendors with known location (e.g., store 118, venue 122, etc.). For example, mobile vendor 120 may be a food truck, an ice cream cart, a pet grooming van or truck, or any other mobile provider of goods and services. In another example, store 118 may be any provider of goods or services with a predetermined physical location. In yet another example, venue 122 may be a sports stadium or arena, a mall, a shopping center, a shopping district, or other venue with a predetermined physical location that comprises a collection of vendors. Vendors may communicate with network 102 using vendor client devices (not shown) or other computing and communication devices (not shown).

In some examples, a consumer may use a location aware device (e.g., GPS-enabled vehicle 104, laptop 106, mobile communication device 108, tablet computer 110, computer 112, kiosk computer 114, etc.) to access a marketplace framework (e.g., shown in FIG. 2 and FIG. 3) to request one or more items from a vendor. In some examples, access to a vendor may be gated using one or more criteria determined by the vendor. For example, gating criteria may relate to a vendor's location (e.g., generally or within a venue), hours of operation, a maximum number of orders that may be processed within a given time period, a maximum number of order slots for a pick up time window, etc. In an example, a consumer may have access only to a subset of vendors in a venue (e.g., sports stadium) in proximity to his location (i.e., as identified by a section, row and seat number) in the stadium. In another example, a vendor selling beer in a baseball stadium may restrict beer sales after a certain point in the game (e.g., the bottom of the 7th inning in a baseball game). In yet another example, one vendor may allow consumers within a ten mile radius of the vendor's location to access the vendor's ordering system, while another vendor may allow such access to consumers within a five mile radius. Any criteria relevant to a vendor's provision of items to a consumer may be used to gate requests from a client.

In some examples, system 100 may be implemented with a gateway that directs a request from a location aware device to a particular server if required by a venue or store to which the request is directed. For example, venue 122 might require that requests for concessions or products from the stores within, or associated with, venue 122 be directed to a server (e.g., server 116) located within or operated by venue 122 for licensing reasons (e.g., it only has rights to sell branded products using associated stores). In other examples, system 100 may be implemented with location aware devices, networks, vendors or venues other than those shown in FIG. 1.

FIG. 2 illustrates an exemplary architecture for a location aware mobile marketplace system. Here, architecture 200 includes framework 202, domain model 204, client device 206, vendor order dashboard 208, vendor administration dashboard 210, integration bus 212, external catalog database 214, point of sales system 216, payment processor 218, framework repository 220, order alert system 234, notification service 238, SDK 240, notification provider 242. In some examples, client device 206 may be a location aware device (e.g., the location aware devices shown in FIG. 1). As shown, client device 206 may be operable to communicate directly with various services in framework 202, or client device 206 may be operable to communicate with framework 202 through notification provider 242.

In some examples, domain model 204 may include identity service 222, venue service 224, business rules 230, product catalog service 226, promotion service 228, and order processing service 232. As shown, domain model 204, integration bus 212, notification service 238 and SDK 240, may be implemented as part of framework 202. In some examples, framework 202 may be cloud-based. In other examples, framework 202 may be implemented with more, fewer or different elements.

In some examples, integration bus 212 may be implemented to enable framework 202 to communicate or interact with external systems (e.g., external catalog database 214, point of sales system 216, payment processor 218, vendor order dashboard 208, vendor administration dashboard 210, etc.). Integration bus 212 may be adapted to support interactions with any number of external systems. In some examples, external catalog database 214 may store, and provide to framework 202, items (e.g., goods (i.e., products) or services) available to be provided (e.g., sold, rented, delivered, etc.) by one or more vendors. For example, framework 202 may retrieve an available catalog associated with an appropriate vendor in response to a request from client device 206. In some examples, point of sales system 216 may be a physical “checkout” system, such as a cash register or checkout kiosk, or it may be an e-commerce or online “checkout” system (via, e.g., mobile application, web application, etc.). In some examples, payment processor 118 may be configured to accept specific types of payment (e.g. credit or debit cards, Paypal®, bank withdrawals, etc.). In other examples, payment processor 118 may be configured to gate payment options according to the preferences of a vendor. For example, a vendor may only accept credit card payments, and another vendor may accept both credit card payments and payments through a third-party payment company (e.g., Paypal®). In another example, a venue (e.g., a sports stadium), may accept only payment by a sponsored type of credit card (e.g., Visa®) for orders made within the venue. In some examples, these and other external systems in a location aware mobile marketplace may be developed or maintained by, and licensed from, a third party.

In some examples, domain model 204 may be implemented with identity service 222, venue service 224, business rules 230, product catalog service 226, promotion service 228, and order processing service 232. In some examples, identity service 222 may enable framework 202 to uniquely recognize client device 206. For example, identity service 222 may operate using traditional identification information (e.g., name, address, credit card number, drivers license number, etc.). In another example, identity service 222 may use electronic identification methods to uniquely identify client device 206 (e.g., secure login (e.g., username and password), radio-frequency identification (RFID), or other unique identifier communicated wirelessly (e.g., via near field communication (NFC) or Bluetooth®). In some examples, identity services 222 may identify client device 206 for the purpose of verifying access privileges or vendor availability for a consumer at a current location. In other examples, identity service 222 may identify client device 206 for the purpose of verifying access privileges for a vendor (e.g., to provide gating criteria or otherwise customize the operation of a gated and automated order processing system).

In some examples, venue service 224 may provide information relating to a venue comprising a group of vendors. In some examples, venue service 224 may use a current location (e.g., from client device 206) to determine an appropriate venue to provide to client device 206. For example, venue service 224 may determine an appropriate (e.g., available) venue by drawing from a set of predetermined venues, by choosing the venue with a known location that matches the current location. In another example, venue service 224 may generate an appropriate (e.g., available) group of vendors dynamically, using various inputs (e.g., from client device 206 (e.g., a current location, a desired radius, etc.), business rules 230, other services in framework 202, etc.). In some examples, venue service 224 may provide data to order processing service 232 associated with one or more catalogs of items (i.e., products) offered by the vendors in the venue. In other examples, venue service 224 may include data associated with an event to take place at an available venue (e.g., type of an event, location of an event, date of an event, start time for an event, end time for an event, etc.) or other information associated with the venue.

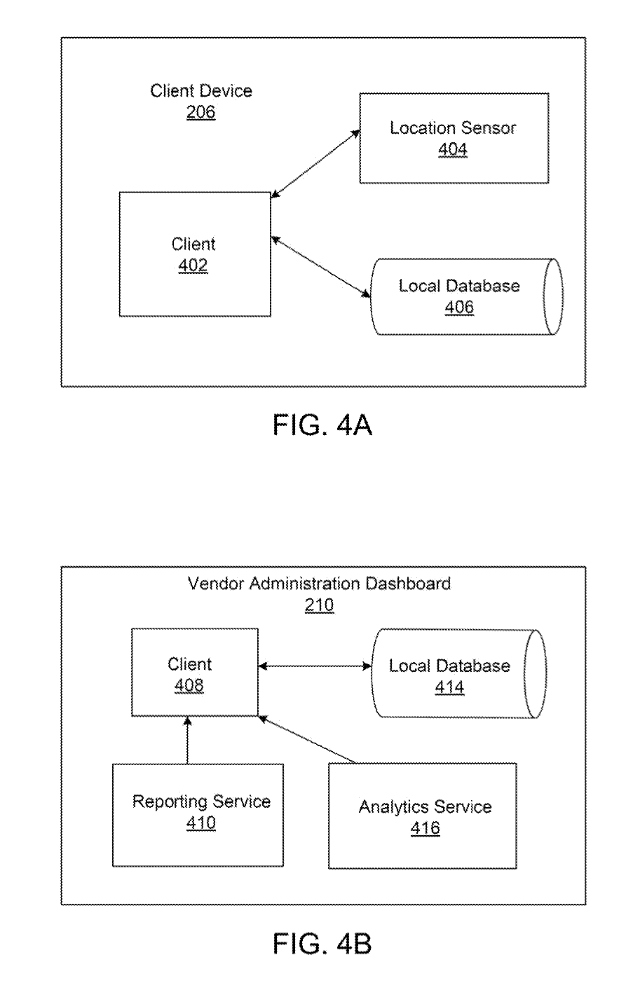

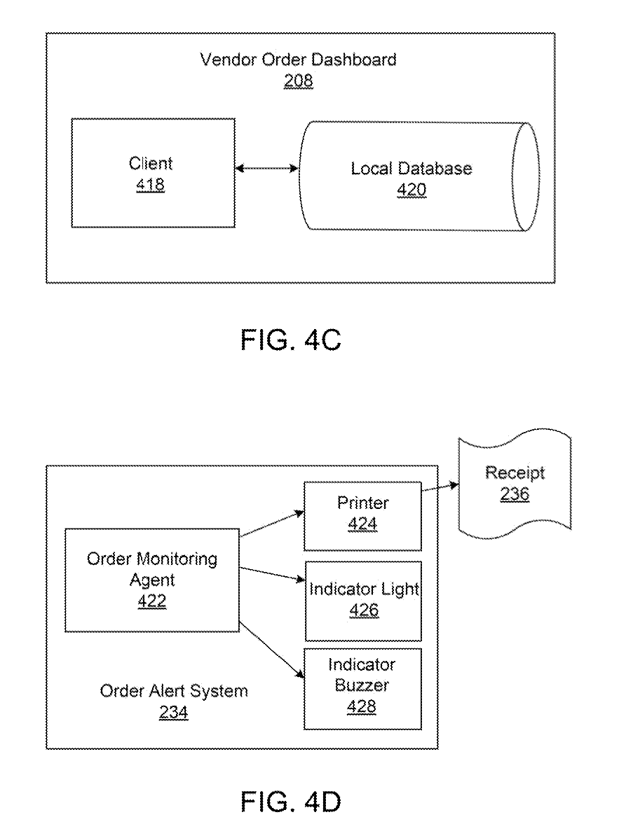

In some examples, product catalog service 226 may provide a catalog of items available to be provided by available vendors. For example, product catalog service 226 may retrieve or provide one or more appropriate catalogs based upon a consumer's choice of vendor, or a determination of vendors available to provide items to a consumer. In some examples, a vendor may have multiple catalogs (e.g., a restaurant might have a lunch menu and a dinner menu) from which product catalog service 226 may select, for example, based on time, date or other criteria. In some examples, once an appropriate catalog is identified, the catalog may be saved on a local database implemented on client device 206 (e.g., shown in FIG. 4A). Such utilization of local storage on client device 206 may reduce the amount of data required to be transferred between client device 206 and framework 202, which may, in turn, mitigate the likelihood of over-taxing bandwidth capabilities (e.g., cellular telephone tower, wireless internet connection, etc.) in a venue or given location.

In some examples, promotion service 228 may be implemented to apply coupons or discounts according to various conditions. In some examples, these conditions may be static (e.g., to the first hundred customers or to customers that input a promotional code). In other examples, the conditions may be dynamic (e.g., based upon fluctuations in demand, environmental factors, or other conditions). In some examples, promotion service 228 also may provide advertisements, for example, to be communicated to client device 206. In some examples, advertisements from promotion service 228 may be provided to client device 206 in the form of a push notification. The push notifications may be provided directly to client device 206, or it may be provided through notification service 238, SDK 240, and notification providers 242 (not shown).

In some example, business rules 230 may update order processing service 232 and promotion service 228. For example, business rules 230 may be implemented to influence prices, availability, service charges, or discounts, relating to orders or items. Business rules 230 may do so according to conditions and other input from promotion service 228, order processing service 232, or other input (e.g., environment input 310 in FIG. 3). Business rules 230 may include static and/or dynamic rules to adapt order processing (e.g., by order processing service 232) to changing conditions, manually, semi-automatically, or automatically.

In some examples, order processing service 232 may be implemented to manage requests received from a client device (e.g., client device 206). For example, order processing service 232 may route, aggregate, and respond to, requests (e.g., orders, requests for presentation of available vendors, requests for presentation of available items, requests for available promotions, etc.), according to various inputs (e.g., from product catalog service 226, client device 206, etc.). For example, order processing service 232 may provide data (e.g., associated with available vendors, items, promotions, etc.) to client device 206 to solicit orders. In some examples, in addition a user of client device 206 to order and purchase items, order processing service 232 may enable consumers to save items for later purchase.

In other examples, order processing service 232 may manage gating criteria customizable by a vendor (e.g., using vendor administration dashboard 210, another client device, etc.). Such gating criteria may include a maximum number of orders with open status at any given time, a target number of orders for a given time period (e.g., a service period, a pick up time, or other time periods), a maximum number of order slots for a pick up time, an active status of a pick-up time, an active status of an order slot, a value of an order slot, or any other criteria that may be relevant to a vendor.

In some examples, order processing service 232 may manage orders received from client device 206 directed to more than one vendor. For example, in response to a request from client device 206, order processing service 232 may provide client device 206 with a list of more than one available vendor, each vendor with at least one available catalog (i.e., menu) of items (e.g., for purchase, rent, etc.). In this example, client device 206 may order items from multiple vendors, and order processing service 232 may aggregate those orders into a single checkout “cart” enabling client device 206 to pay for all of the items using a single payment. In some examples, order processing service 232 may identify the purchases from each vendor using an identification code or tag (e.g., generated by client device 206, vendor order dashboard 208, point of sales system 216, payment processor 218. order alert system 234, or other service implemented with framework 202, shown or not shown). Thus, in this example, purchases associated with each individual vendor may be identified separately for later use (e.g., returns, disputes, etc.). In some examples, order processing service 232 may provide notifications to client device 206 through notification service 238, SDK 240 and notification provider 242. For example, order processing service may indicate to notification service 238 that an order is ready for pick-up or delivery, and notification service 238 may prompt notification provider 242, using SDK 240, to push a notification message to client device 206 indicating the order is ready for pick-up, or the order will be delivered shortly. In other examples, notification service 238 may be implemented as part of order processing service 232, and notification provider 242 may be implemented as part of framework 202. In still other examples, order processing service 232 may be implemented to provide notifications directly to client device 206. In yet other examples, notification may be provided to client device 206 differently than described herein.

In some examples, architecture 200 may include vendor order dashboard 208, order alert system 234, and vendor administration dashboard 210. For example, vendor order dashboard 208 may be an order system operable by a vendor (FIG. 4C). In some examples, vendor order dashboard 208 may work in conjunction with order alert system 234 to present vendors with alerts associated with orders (FIG. 4D), for example, to generate receipt 236. In another example, vendor administration dashboard 210 may be implemented to enable a vendor to update various modules or services within framework 202 (FIG. 4B). In other examples, architecture 200 may be implemented with more, fewer or different elements.

FIG. 3 illustrates an exemplary architecture for a gated and automated order processing system implemented in a location aware mobile marketplace. Here, cloud framework 302 may include domain model 304, integration bus 312 and framework repository 320. In some examples, domain model 304 may further include identity service 322, event service 324, product catalog service 326, promotion service 328, business rules 330 and order processing service 332. In some examples, cloud framework 302 may be implemented in conjunction with external catalog database 314, point of sales system 316 and payment processor 318. Domain model 304, identity service 322, product catalog service 326, promotion service 328, business rules 330 and order processing service 332 may be implemented in the same or similar manner as like-named elements in FIG. 2. Integration bus 312, framework repository 320, external catalog database 314, point of sales system 316 and payment processor 318 also may be implemented in the same or similar manner as like-named elements in FIG. 2. In some examples framework repository 320 may be implemented as part of cloud framework 302. In other examples, framework repository 320 may be implemented separately.

In some examples, cloud framework 302 may be implemented using a cloud-based platform, and otherwise be implemented similarly as framework 202. In some examples, event service 324 may be implemented to provide information relating to a nearby or on-location event with which one or more vendors may be associated. For example, event service 324 may use a current location (e.g., of client device 206 (FIG. 2)) to determine and provide information (e.g., to order processing service 332) relevant to an available vendor's catalog of items for purchase. In some examples, such information may include a type of an event, a location of an event, a date of an event, a start time for an event, an end time for an event, or other information associated with an event. Similarly to venue service 224 (FIG. 2), event service 324 may determine a nearby or on-location event by drawing from a set of predetermined venues, or dynamically using various inputs (e.g., from client device 206 (e.g., a current location, a desired radius, etc.), business rules 330, other services in cloud framework 302, etc.).

FIGS. 4A-4D illustrate exemplary architectures for components of a location aware mobile marketplace system. FIG. 4A illustrates an exemplary architecture for client device 206. Here, client device 206 may include client 402, location sensor 404 and local database 406. In some examples, client 402 may be a system or application that accesses a remote server on another system (e.g. computer, server, network, etc.). For example, client 402 may be an application (e.g., “app”) downloaded onto, and used with, a mobile communication device (e.g., mobile communication device 108 and tablet computer 110 (FIG. 1)). In this example, client 402 may be an application operable to communicate with framework 202 (and services and modules within framework 202). For example, client 402 may be operable to send requests to, and to receive notifications from, framework 202. In some examples, location sensor 404 may use determine a current location of client device 206 using native GPS methods or systems. In other examples, location sensor 404 may use other methods for determining a current location (e.g., cell phone tower triangulation, accessing stationary WiFi networks in known locations, etc.). In some examples, local database 406 may provide data storage for any data that may be used by client device 206. For example, local database 406 may store data associated with client 402, data associated with catalogs received from framework 202 (FIG. 2), or other data useful for providing services to a user of client device 206. In other examples, client device 206 may be implemented differently than described herein.

FIG. 4B illustrates an exemplary architecture for vendor administration dashboard 210. Here, vendor administration dashboard 210 may include client 408, reporting service 410, local database 414, and analytics service 416. In some examples, client 408 may be implemented similarly to client 402. For example, client 408 may be a system or application that accesses a remote server on another system (e.g. computer, server, network, etc.); may be an application (e.g., “app”) downloaded onto, and used with, a mobile communication device (e.g., mobile communication device 108 and tablet computer 110 (FIG. 1)); and may be an application operable to communicate with framework 202 (and services and modules within framework 202), including sending requests to, and receiving notifications from, framework 202. In some examples, vendor administration dashboard 210 may be implemented to enable a vendor to update various modules or services within a location aware mobile marketplace framework (e.g., framework 202 (FIG. 2) and cloud framework 302 (FIG. 3)) using client 408. For example, a vendor may use vendor administration dashboard 210 to update business rules (e.g., business rules 230 and 330 (FIGS. 2-3)), product catalog services (e.g., product catalog service 226 and 326 (FIGS. 2-3)), promotion services (e.g., promotion service 228 and 328 (FIGS. 2-3)), or other services. In some examples, local database 414 may store business data associated with consumer activity, including consumer purchases, returns, catalog browsing history, and other consumer activity. In other examples, local database 414 may be implemented to store other data useful to the operation of vendor administration dashboard 210 or to a user of vendor administration dashboard 210. In some examples, reporting service 410 may create and maintain reports relating to consumer activity. For example, reporting service 410 may create and maintain reports associated with consumer purchases, catalog browsing history, returns, and other important business data. In some examples, analytics service 416 may provide statistical analysis and modeling functions for a vendor, using the business data stored in local database 414. In other examples, vendor administration dashboard 210 may be implemented differently than described herein.

FIG. 4C illustrates an exemplary architecture for vendor order dashboard 208. Here, vendor order dashboard may include client 418 and local database 420. In some examples, client 418 may be implemented similarly to clients 402 and 408. For example, client 418 may be a system or application that accesses a remote server on another system (e.g. computer, server, network, etc.); may be an application (e.g., “app”) downloaded onto, and used with, a mobile communication device (e.g., mobile communication device 108 and tablet computer 110 (FIG. 1)); and may be an application operable to communicate with framework 202 (and services and modules within framework 202), including sending requests to, and receiving notifications from, framework 202. In some examples, vendor order dashboard 208 may be implemented to enable a vendor to communicate with various modules or services within a location aware mobile marketplace framework (e.g., framework 202 (FIG. 2) and cloud framework 302 (FIG. 3)) using client 418. In some examples, vendor order dashboard 208 may be an order system operable by a vendor. In some examples, vendor order dashboard 208 may be a vendor's already existing order system, which is implemented to present orders both directly on a point-of-sale system operated by the vendor at the vendor's physical location, and also from client device 206, or other client devices, using framework 202. For example, vendor order dashboard 208 may integrate orders received through framework 202 into the vendor's overall queue of orders, for example, in the order in which the requests are received. In other examples, vendor order dashboard 208 may be dedicated to presenting orders solely received through framework 202. In still other examples, vendor order dashboard 208 may be implemented differently than described herein.

FIG. 4D illustrates an exemplary architecture for order alert system 234. Here, order alert system 234 may include order monitoring agent 422, printer 424, indicator light 426 and indicator buzzer 428. In some examples, printer 424 may produce receipt 236, which may be a printout of the order (e.g., for the vendor to fulfill). In other examples, receipt 236 may be generated differently (e.g., electronic mail, text message, or otherwise communicated (e.g., using a client device)). In some examples, order alert system 234 may notify vendors when orders are being received through framework 202. For example, order monitoring agent 422 may communicate with various services or modules within framework 202 (e.g., order processing service 232, etc.) or cloud framework 302 (e.g., order processing service 332, etc.) to determine when an order is received. Then, order alert system 234 may alert a vendor of the incoming order using one or more of printer 424, indicator light 426 and indicator buzzer 428. In other examples, order alert system 234 may be implemented differently than described herein.

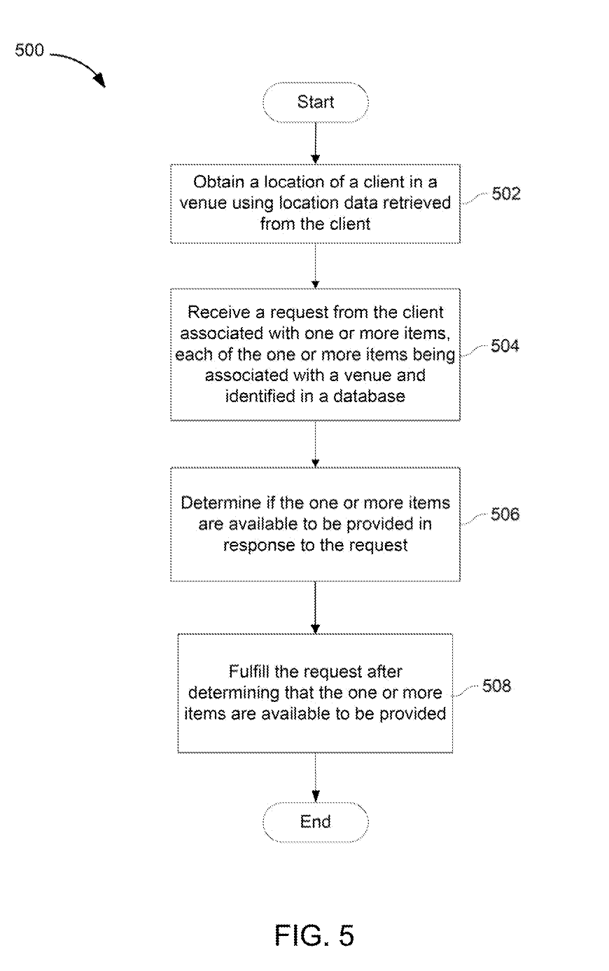

FIG. 5 illustrates an exemplary process for fulfilling a client request in a location aware mobile marketplace. In some examples, process 500 may begin with obtaining a location of a client in a venue using location data retrieved from the client (502). Location data may include any data received from a client that is associated with a location (e.g., the client's current geographic location, a radius surrounding the client's current location, a requested venue, a location within a venue (e.g., section, row and seat numbers in a sports stadium), etc.). In some examples, the client may be presented with a screen or form (e.g., via an application on a mobile communication device) for entry of location data. In other examples, the client may automatically generate location data (e.g., using built-in GPS capabilities) and transmit them to a location aware mobile marketplace framework (e.g., framework 202 (FIG. 2) or cloud framework 302 (FIG. 3)). After obtaining a location of a client, a request from the client associated with one or more items may be received, each of the one or more items being associated with a venue and identified in a database (504). In some examples, the one or more items may be a subset of a catalog of items available from stores associated with (e.g., located in, affiliated with, in delivery or pick-up proximity to, etc.) the venue. In some examples, the request may be an order for the one or more items. In some examples, each of the one or more items may be provided by a different store within, or associated with, the venue. In other examples, all of the one or more items may be provided by a single store. Once the request is received, a determination may be made whether the one or more items are available to be provided in response to the request (506). In some examples, such determination may comprise reconciling the request against one or more criteria. For example, the store may offer different items at different times of the day, for different events, depending on inventory levels or various environmental factors, or other criteria. In some examples, the store may create, customize and/or use business rules (as may be implemented using, e.g., business rules 230 and 330), promotions (as may be implemented using, e.g., promotion services 228 and 328), or other criteria (as may be implemented using, e.g., order processing services 232 and 332), to determine whether an item is available to a consumer at a given time, a given place, or under a given circumstance. After determining that the one or more items are available to be provided, the request may be fulfilled (508), e.g., by a store associated with the venue. In some examples, fulfilling the request may entail preparing the item to be provided (e.g., to a user of the client from which the request was received). In some examples, the item may be picked up. In other examples, the item may be delivered to the location, or to another location designated by the client for delivery. In still other examples, process 500 may be implemented with more, fewer or different steps.

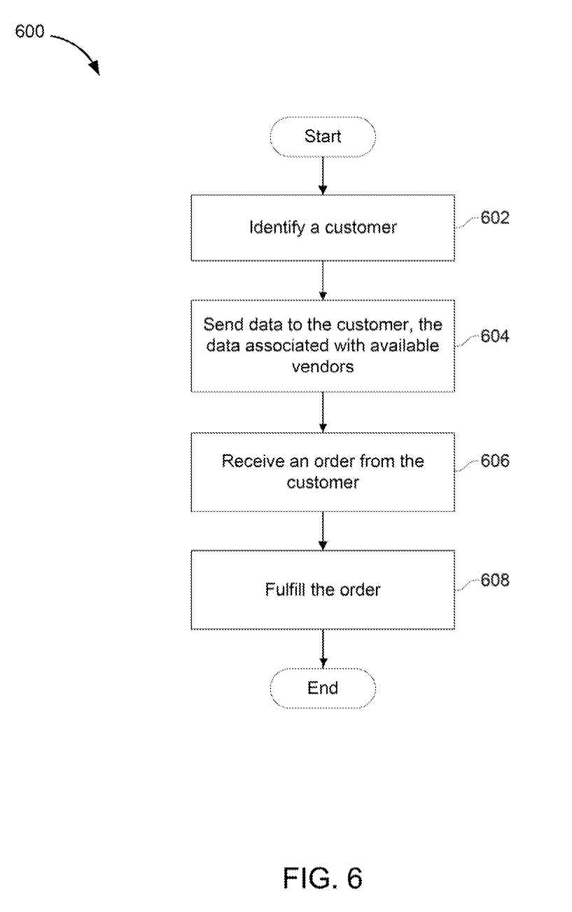

FIG. 6 illustrates an exemplary process for fulfilling an order in a location aware mobile marketplace. In some examples, process 600 may begin with identifying a customer (602). In some examples, identifying a customer may include uniquely identifying a client device. For example, traditional identification information (e.g., name, address, credit card number, drivers license number, etc.) may be retrieved or received. In another example, electronic identification methods may be used to uniquely identify a client device (e.g., secure login (e.g., username and password), radio-frequency identification (RFID), or other unique identifier communicated wirelessly (e.g., via near field communication (NFC) or Bluetooth®). In some examples, after, or in conjunction with, obtaining identification data from a customer, location data may also be retrieved from the customer (e.g., a customer's usual location, a customer's current location, a customer's desired location, etc.). Once a customer is identified, data may be sent to the customer, the data associated with available vendors (604). In some examples, the availability of vendors may be determined using gating criteria, both static and dynamic, as described above. Once the customer is presented with available vendor options, an order may be received from the customer (606). In some examples, the customer may be presented further with various catalogs or menus of available items from available vendors, to browse and select. In some examples, the order may be processed according to additional gating criteria to determine whether the order may be fulfilled. In other examples, the gating criteria may be implemented prior to providing the customer with available items to select or purchase, in which case the order may be fulfilled (608) upon receipt of the order without further analysis. In some examples, fulfilling the request may entail preparing the item to be provided (e.g., to a user of the client from which the request was received). In some examples, the item may be picked up. In other examples, the item may be delivered to the location, or to another location designated by the client for delivery. In still other examples, process 600 may be implemented with more, fewer or different steps.

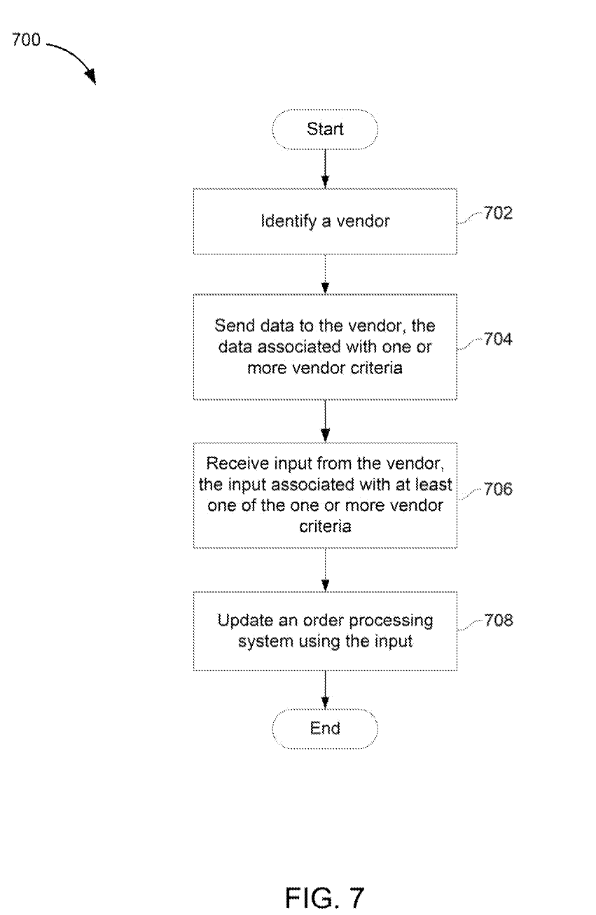

FIG. 7 illustrates an exemplary process for updating an order processing system in a location aware mobile marketplace. In some examples, process 700 may begin with identifying a vendor (702). In some examples, identifying a vendor may include uniquely identifying a client device. For example, traditional identification information (e.g., name, address, credit card number, drivers license number, etc.) may be retrieved or received. In another example, electronic identification methods may be used to uniquely identify a client device (e.g., secure login (e.g., username and password), radio-frequency identification (RFID), or other unique identifier communicated wirelessly (e.g., via near field communication (NFC) or Bluetooth®). In some examples, a secure identification method may be employed to verify a vendor's access privileges to a location aware mobile marketplace system. For example, a vendor may have access to update or customize vendor criteria (e.g., gating criteria) associated with the processing of orders for that vendor, but not for updating or customizing another vendor's vendor criteria. Once the vendor is identified, data may be sent to the vendor, the data associated with one or more vendor criteria (704). In some examples, vendor criteria may be associated with a vendor's location, hours of operation, the weather or other environmental factors, a vendor's inventory, or more specifically, a maximum number of orders with open status at any given time, a target number of orders for a given time period (e.g., a service period, a pick up time, or other time periods), a maximum number of order slots for a pick up time, an active status of a pick-up time, an active status of an order slot, a value of an order slot, or any other criteria relevant to a vendor's ability to provide items to customers. For example, a vendor may choose to limit access to, or visibility of, its catalogs and ordering systems based on the vendor's hours of operation or location (current or permanent). In another example, a venue that is a sports arena or stadium may limit access to, or visibility of, its catalogs and ordering system during an off season. After data associated with one or more vendor criteria is sent to the vendor, input may be received from the vendor, the input associated with at least one of the one or more vendor criteria (706). In some examples, the input may be used to update the one or more vendor criteria. In other examples, the input may be used to customize the one or more vendor criteria for the vendor. In still other examples, the input may be used to create new vendor criteria. The input may then be used to update an order processing system (708), the order processing system operable to process orders for the vendor. In other examples, process 700 may be implemented with more, fewer or different steps.

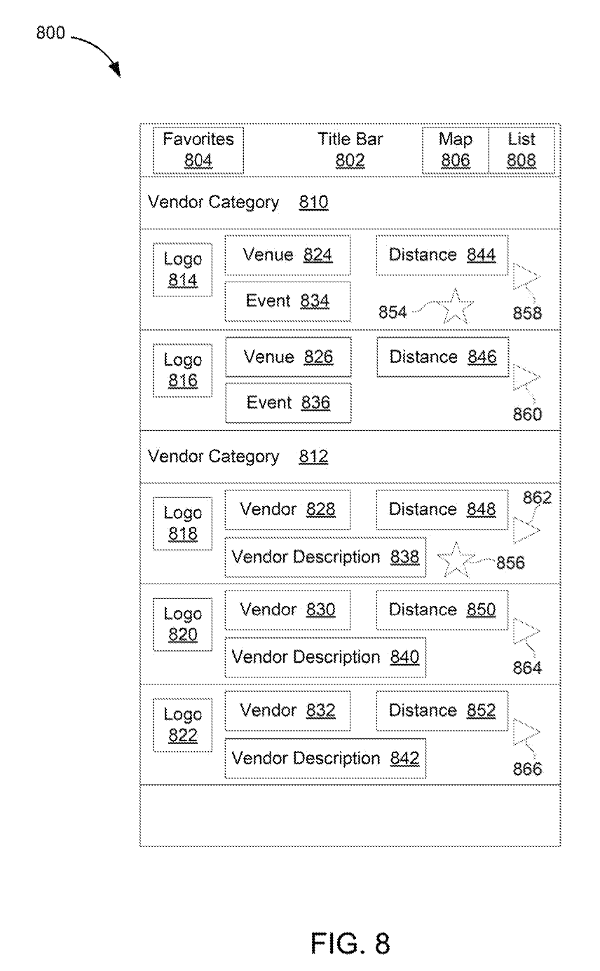

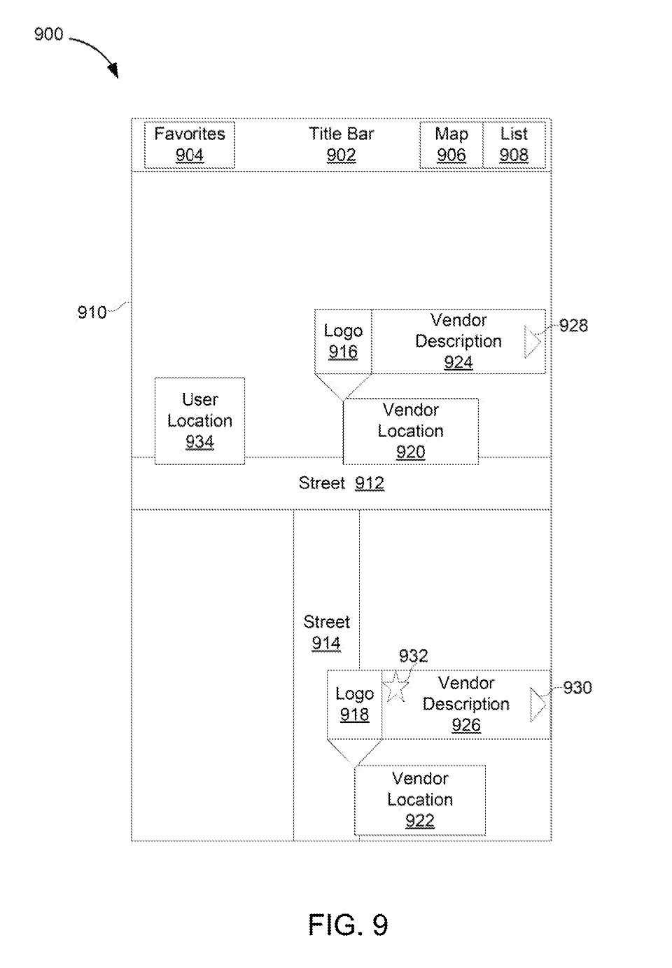

FIG. 8 illustrates an exemplary wireframe of a screen for vendor selection. Here, wireframe 800 may include title bar 802, favorites button 804, map button 806, list button 808, vendor categories 810-812, logos 814-822, venues 824-826, vendors 828-832, events 834-836, vendor descriptions 838-842, distances 844-852, feature icons 854-856, and selection buttons 858-866. In some examples, title bar 802 may display a title, or other phrase, identifying the screen. For example, for a screen displaying available venues and vendors, title bar 802 may display the title, “Venues and Merchants” or “Venues and Vendors” or other appropriate title. In some examples, favorites button 804 may enable a user to navigate to a screen displaying a user's favorite venues, locations or vendors (not shown). In some examples, map button 806 may enable a user to navigate to a screen displaying available venues or vendors on a map (FIG. 9). In some examples, list button 808 may enable a user to navigate to a screen displaying available venues or vendors in a list, e.g., the list format displayed in wireframe 800. In some examples, vendor categories 810-812 may display the categories of vendors available to provide items to a user, e.g., at a current location and current time. For example, vendor category 810 may be nearby stadiums, and vendor category 812 may be nearby mobile food vendors (e.g., food trucks). In other examples, vendor categories 810-812 may include other mobile vendors, malls, shopping centers, or other types of vendors. In some examples, venues 824-826 may identify (e.g., display names of) venues. In the example where vendor category 810 is stadiums, venues 824-826 may display names of nearby stadiums. In some examples, logo 814 may display a logo signifying, representing, chosen by, or otherwise associated with, venue 824, and logo 816 likewise may display a logo associated with venue 826. In some examples event 834 may display information associated with an event occurring at venue 824, and event 836 likewise may display information associated with an event occurring at venue 826. For example, event 834 may indicate the teams playing in the event at venue 824, a date of the event, a start time of the event, an end time of the event, or other information associated with the event. Event 836 may display similar types of information with respect to an event taking place at venue 826.

In some examples vendors 828-832 may identify (e.g., display names of) vendors in vendor category 812. In the example where vendor category 812 is mobile food vendors, vendors 828-832 may display names of nearby food trucks. In some examples, logos 818-822 may display logos associated with vendors 828-832, respectively. In sonic examples, vendor descriptions 838-842 may display descriptions of vendors 828-832, respectively. For example, vendor description 838 may display the type of item sold by vendor 828, the current location of vendor 828, a date and time during which vendor 828 is available, or other information associated with vendor 828. Vendor descriptions 840 and 842 may display similar types of information with respect to vendors 830 and 832, respectively.

In some examples, distances 844 and 846 may indicate distances between venue 824 and 826, respectively, and a current location of the user. Distances 848-852 likewise may display distances between vendors 828-832, respectively, and a current location of the user. In some examples, selection buttons 858 and 860 may enable a user to select venues 824 and 826, respectively. For example, selection button 858 may enable a user to navigate to a screen associated with venues 824. For example, touching selection buttons 858 may navigate a user to a screen displaying a list or map of stores associated with venue 824, a list of item categories associated with venue 824, a list of items associated with venue 824, or other screens associated with venue 824. Selection button 860 likewise may operate similarly with respect to venue 826, and selection buttons 862-866 may operate similarly with respect to vendors 828-832, respectively.

In some examples, feature icons 854-856 may be used to indicate a featured venue (e.g., venue 824) or vendor (e.g., vendor 828). Venues and vendors may be featured for a variety of reasons. For example, venue 824 and vendor 828 may be featured for being the closest proximate venue and vendor to a user's current location. In another example, venue 824 and vendor 828 may be featured because they are most frequented by a user, is a designated favorite of the user, has a promotion applicable to the user, or for any other reason. In other examples, a screen for vendor selection may be implemented differently than described herein.

FIG. 9 illustrates an exemplary wireframe of a screen showing vendor selection options on a map interface. Here, wireframe 900 may include title bar 902, favorites button 904, map button 906, list button 908, and map 910, which may display streets 912-914, logos 916-918, vendor locations 920-922, vendor descriptions 924-926, selection buttons 928-930, feature icon 932 and user location 934. In some examples, title bar 902 may display a title, or other phrase, identifying the screen (e.g., “Map”). In some examples, favorites button 904 may enable a user to navigate to a screen displaying a user's favorite venues, location or vendors (not shown). In some examples, map button 906 may enable may enable a user to navigate to a screen displaying available venues or vendors on a map (e.g., map 910). In some examples, list button 908 may enable a user to navigate to a screen displaying available venues or vendors in a list (e.g. FIG. 8). In some examples, vendor descriptions 924 and 926 may display information associated with vendors at vendor locations 920 and 922, respectively. For example, vendor description 924 may display the name of a first vendor (e.g., food truck, other mobile vendor, or stationary vendor) located on street 912, along with other information that may be pertinent to a customer (e.g., open dates and times, type of food served, etc.). In this example, vendor location 920 may indicate an address for, or otherwise indication the location of, the first vendor. Also in this example, vendor description 926 may display the same or similar types of information for a second vendor (e.g., food truck, other mobile vendor, or stationary vendor) located on street 914, the exact location for which may be displayed by vendor location 922.

In some examples, logos 916 and 918 may display logos associated with the first vendor and the second vendor, respectively. In some examples, selection buttons 928 and 930 may enable a user to select the first vendor and the second vendor, respectively. For example, selection button 928 may enable a user to navigate to a screen associated with the first vendor (i.e., located on street 912). For example, touching selection button 928 may navigate a user to a screen displaying a list of items associated with the first vendor, a list of item categories associated with the first vendor, or other screens associated with the first vendor. Selection button 930 likewise may operate similarly with respect to the second vendor. In some examples, feature icon 932 may indicate a featured vendor (e.g., the second vendor located on street 914). A vendor may be featured for a variety of reasons. For example, the second vendor may be featured for being the closest proximate vendor to user location 934, be the most frequented vendor by a user in proximity to user location 934, be a designated favorite of the user, have a promotion applicable to the user, or for any other reason. In other examples, a screen showing vendor selection options on a map interface may be implemented differently than described herein.

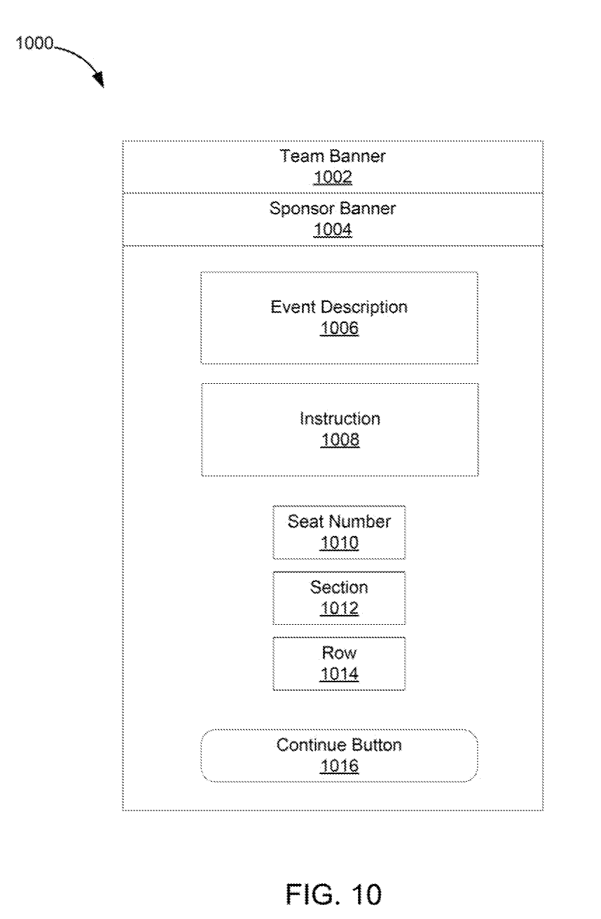

FIG. 10 illustrates an exemplary wireframe of a screen for entering location information. Here, wireframe 1000 may include team banner 1002, sponsor banner 1004, event description 1006, instruction 1008, seat number 1010, section 1012, row 1014, and continue button 1016. In some examples, team banner 1002 may display a logo, advertisement, or other graphic and/or text associated with a team (e.g., home team) associated with a venue (e.g., a stadium) or event (e.g., a game). In some examples, sponsor banner 1004 may display a logo, advertisement, or other graphic and/or text associated with a sponsor (e.g., a game sponsor) associated with a venue or event. In some examples, team banner 1002 and sponsor banner 1004 may comprise a link or button enabling a user to navigate to a screen associated with the team or sponsor, respectively. In some examples, event description 1006 may display information associated with an event (e.g., game location, team information, game date, game time, etc.). In some examples, instruction 1008 may provide instructions for completing seat number 1010, section 1012, and row 1014. For example, instruction 1008 may display a pre-set message instructing a user to provide the user's seat information, e.g., for the purpose of validating services available to a user at the event. In some examples, seat number 1010, section 1012, and row 1014, may be implemented as fields in which a user may enter the user's scat number, section and row information, respectively, to indicate a location. In some examples, this location may be used by vendors associated with the venue or event to deliver purchased items to the user. In some examples, continue button 1016 may enable a user to navigate to a next screen (e.g., displaying available categories of vendors, available categories of items, available items, etc.). In other examples, a screen for entering location information may be implemented differently than described herein.

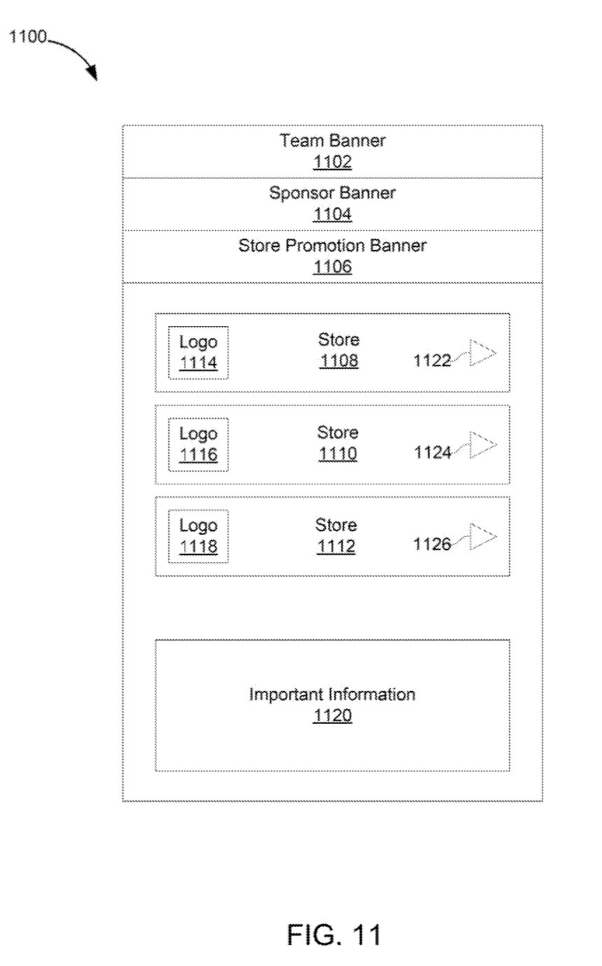

FIG. 11 illustrates an exemplary wireframe of a screen for store selection. Here, wireframe 1100 may include team banner 1102, sponsor banner 1104, store promotion banner 1106, stores 1108-1112, logos 1114-1118, important information 1120, and selection buttons 1122-1126. Team banner 1102 may be implemented in the same or similar manner as team banner 1002, and sponsor banner 1104 may be implemented in the same or similar manner as sponsor banner 1004. In some examples, store promotion banner 1106 may display a logo, advertisement, or other graphic or text associated with a store promotion. In some examples, store promotion banner 1106 may comprise a link or button enabling a user to navigate to a screen associated with a store promotion. In some examples, stores 1108-1112 may identify (e.g., display names or descriptions) stores available to be selected (e.g., from which items may be purchased) by a user. For example, stores 1108-1112 may identify an in-seat food service, a coffee bar, a team store, a stadium parking service, a ticket service, or other store or service associated with a venue or event that may be available to a user. In some examples, logos 1114-1118 may display logos associated with stores 1108-1112, respectively. In some examples, important information 1120 may display various important information related to use of the store selection screen, the application, or the location aware mobile marketplace. For example, important information 1120 may display information associated with payment, order timing, delivery timing, logistics, or other information. In some examples, selection buttons 1122-1126 may enable a user to select each of stores 1108-1112, respectively. For example, selection button 1122 may enable a user to select store 1108 in order to navigate to a screen associated with store 1108 (e.g., a list of available item categories, a list of available items, a display of promotions, etc.). Selection button 1124 likewise may operate similarly with respect to store 1110, and selection button 1126 likewise may operate similarly with respect to store 1112. In other examples, a screen for store selection may be implemented differently than described herein.

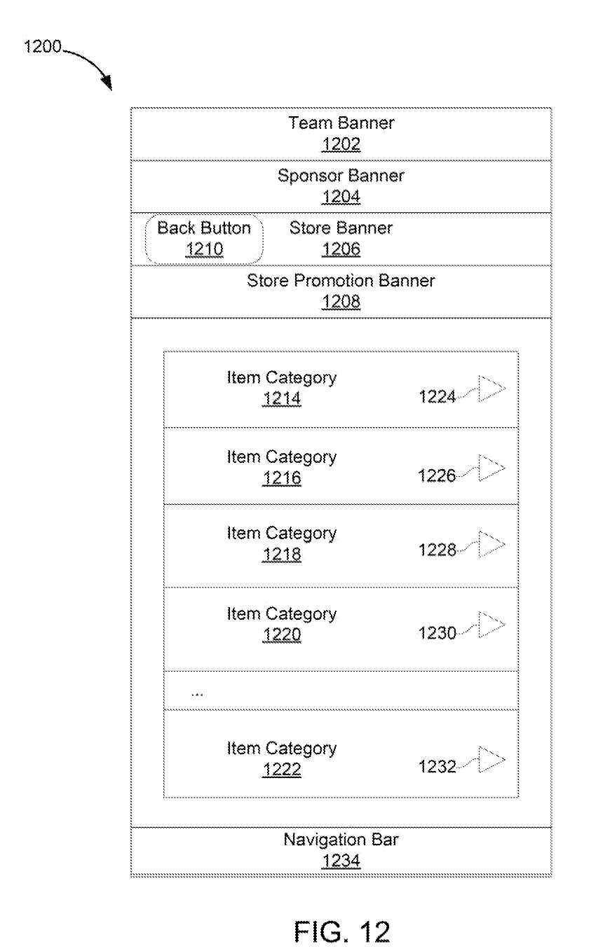

FIG. 12 illustrates an exemplary wireframe of a screen for item category selection. Here, wireframe 1200 may include team banner 1202, sponsor banner 1204, store banner 1206, store promotion banner 1208, back button 1210, item categories 1214-1222, selection buttons 1224-1232, and navigation bar 1234. Team banner 1202, sponsor banner 1204, store promotion banner 1208 and selection buttons 1224-1232 may be implemented in the same or similar manner as like-named elements in FIGS. 10-11. In some examples, store banner 1206 may display a logo, advertisement, or other graphic or text associated with a store. In some examples, store banner 1206 may comprise a link or button enabling a user to navigate to a screen associated with a store. In some examples, back button 1210 may enable a user to navigate back to a previous screen. For example, if a user navigated to this item category selection screen from a store selection screen, back button 1210 may enable a user to navigate back to the store selection screen. In some examples, item categories 1214-1222 may identify categories of items available to be provided by the store. For example, item categories 1214-1222 for a restaurant or concession stand may include specials, food, snacks, drinks, or other categories of items for sale. In some examples, navigation bar 1234 may comprise various links or buttons for navigating to different screens in the application. For example, navigation bar 1234 may include a vendors button for navigating to a screen displaying vendors, a history button for navigating to a screen displaying a user's browsing history, a location button for navigating to a screen for entering location information, a pay button for navigating to a payment screen, as well as other buttons for navigating to other screens. In other examples, a screen for item category selection may be implemented differently than described herein.

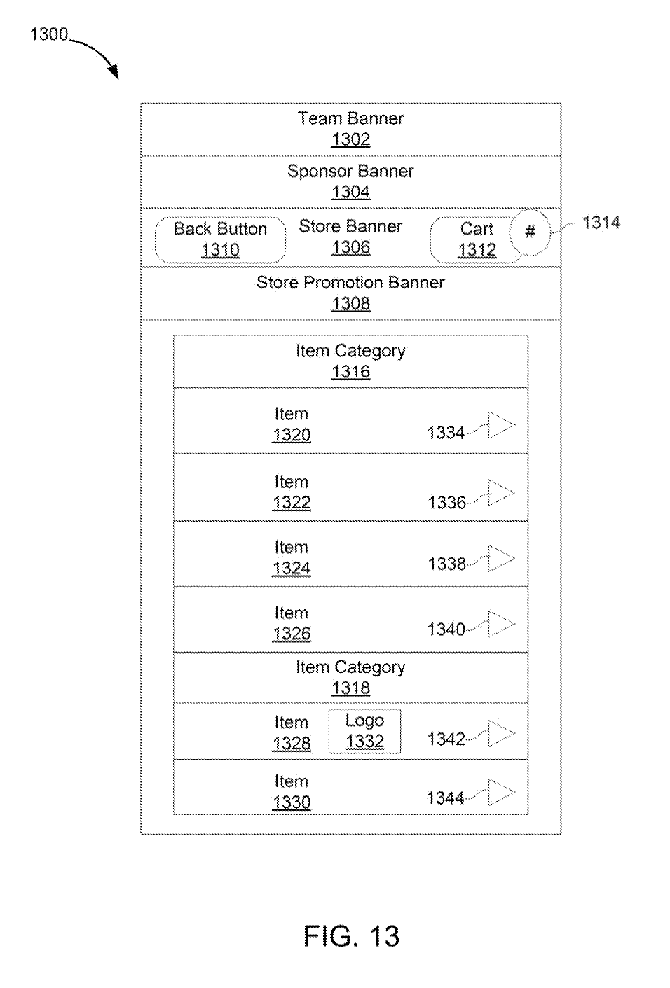

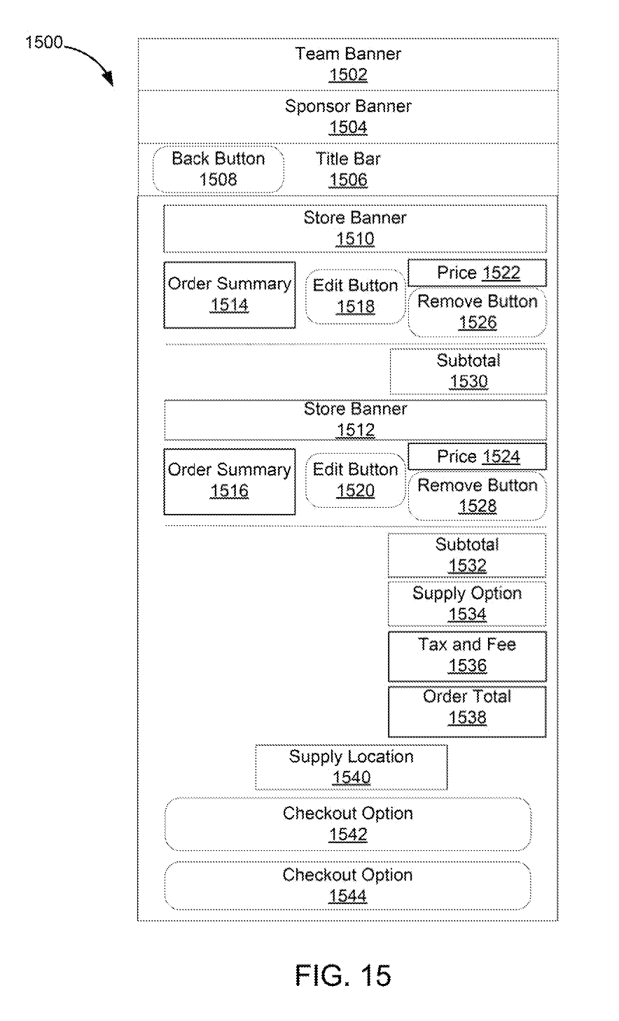

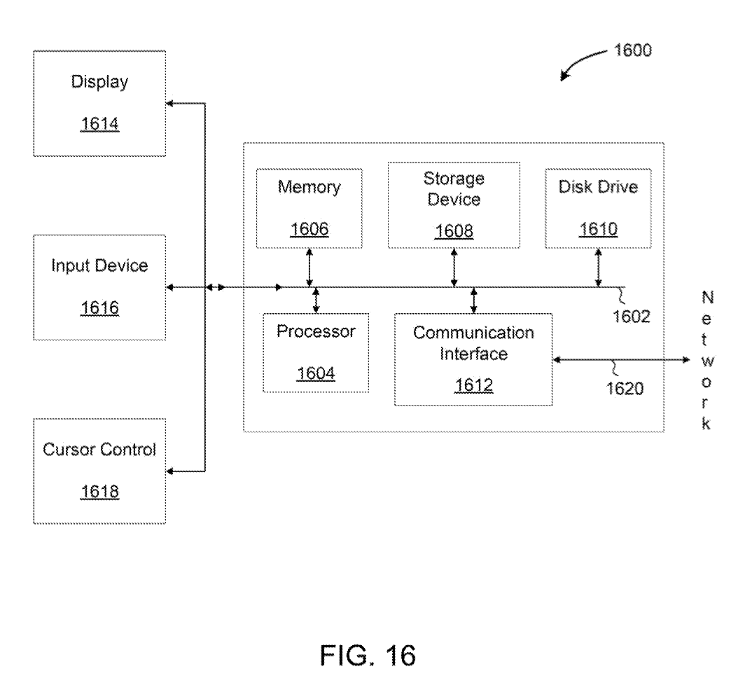

FIG. 13 illustrates an exemplary wireframe of a screen for item selection. Here, wireframe 1300 may include team banner 1302, sponsor banner 1304, store banner 1306, store promotion banner 1308, back button 1310, cart 1312, cart item number 1314, item categories 1316 and 1318, items 1320-1330, logo 1332, and selection buttons 1334-1344. Team banner 1302, sponsor banner 1304, store banner 1306, store promotion banner 1308, back button 1310 and selection buttons 1334-1344 may be implemented in the same or similar manner as like-named elements in FIGS. 10-12. In some examples, cart 1312 may be implemented as a button that enables a user to navigate to a cart screen (FIG. 15) displaying items selected to be purchased. The number of items in a user's cart may be indicated by cart item number 1314. In some examples, item category 1316 may indicate the category of items that comprise items 1320-1326, and item category 1318 may indicate the category of items that comprise items 1328-1330. For example, item category 1316 may be food, and items 1320-1326 may include food items (e.g., hot dog, cheeseburger, chips, nachos, etc.). In another example, item category 1318 may be drinks, and items 1328-1330 may include drink items (e.g., beer, soda, coffee, water, etc.). In some examples, logo 1332 may display a logo, advertisement, or other graphic or text associated with item 1328. For example, item 1328 may be a brand of beer, and logo 1332 may be a logo for that brand of beer. In other examples, a screen for item selection may be implemented differently than described herein.

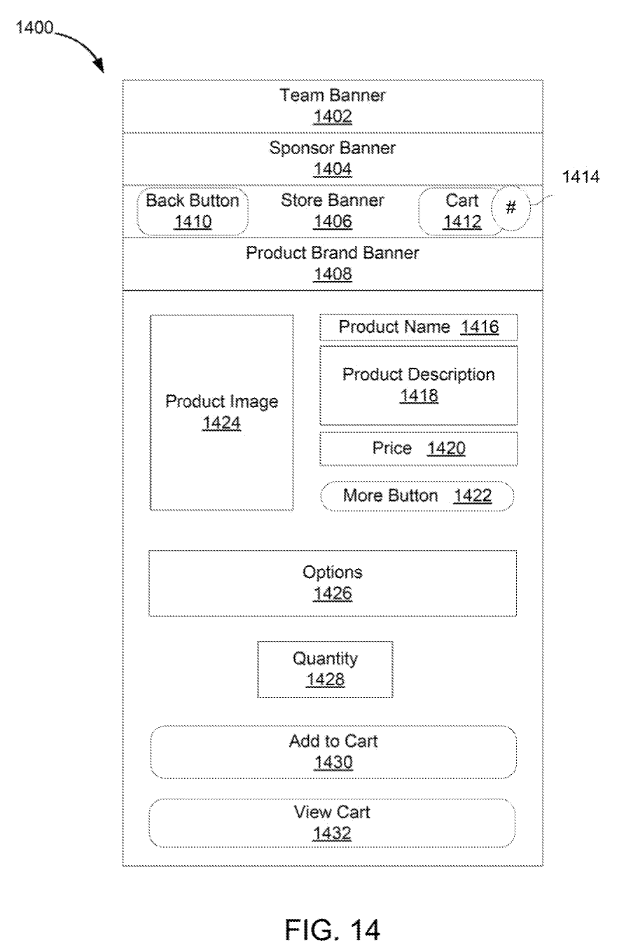

FIG. 14 illustrates an exemplary wireframe of a product screen. Here, wireframe 1400 may include team banner 1402, sponsor banner 1404, store banner 1406, product banner 1408, back button 1410, cart 1412, cart item number 1414, product name 1416, product description 1418, price 1420, more button 1422, product image 1424, options 1426, quantity 1428, add to cart 1430 and view cart 1430. Team banner 1402, sponsor banner 1404, store banner 1406, back button 1410, cart 1412 and cart item number 1414 may be implemented in the same or similar manner as like-named elements in FIGS. 10-13. In some examples, product name 1416 may display the name of a product (e.g., a brand of beer or soda, etc.). In some examples, product description 1418 may display a description of the product, or other information associated with the product. In some examples, price 1420 may display a price for the product, and product image 1424 may display an image or picture of the product. In some examples, more button 1422 may enable a user to navigate to a screen displaying more information about the product or the brand. In some examples, options 1426 may be implemented as a widget, field, pull-down menu, or other method of selecting options associated with the product. For example, if the product is beer, options 1426 may enable a user to select a type of beer, a brand of beer, a size, or other option. In some examples, quantity 1426 may be implemented as a widget, field, pull-down menu, or other method for entering or selecting a quantity. In some examples, add to cart 1428 may be implemented as a button or link enabling a user to add the product to the user's cart, in the quantity indicated in quantity 1426 and at the price indicated in price 1420. In some examples, after a product is added to a cart, a user may navigate to other screens (e.g., using back button 1410, store banner 1406, product brand banner 1408, etc.), for example, to continue browsing and purchasing other products. In some examples, view cart 1430 may be implemented as a button or link enabling a user to view the user's cart, for example, without adding the product on the current screen to the cart. In other examples, a product screen may be implemented differently than described herein.

FIG. 15 illustrates an exemplary wireframe of a screen displaying selected items and purchase options in a cart. Here, wireframe 1500 may include team banner 1502, sponsor banner 1504, title bar 1506, back button 1508, store banners 1510-1512, order summaries 1514-1516, edit buttons 1518-1520, prices 1522-1524, remove buttons 1526-1528, subtotals 1530-1532, supply option 1534, tax and fee 1536, order total 1538, supply location 1540, checkout options 1542-1544. Team banner 1502, sponsor banner 1504, title bar 1506, back button 1508, store banners 1510-1512, and prices 1522-1524 may be implemented in the same or similar manner as like-named elements in FIGS. 8-13. For example, title bar 1506 for a screen displaying selected items and purchase options in a cart may display the title “Cart,” or another title or name identifying the screen.

In some examples, the cart screen may display orders from more than one store. For example, store banner 1510 may display a logo, advertisement, or other graphic and/or text associated with a first store, and banner 1512 may display a logo, advertisement, or other graphic and/or text associated with a second store. In this example, order summary 1514 may display a summary of an order placed with the first store, and order summary 1516 may display a summary of an order placed with the second store. Order summaries 1514 and 1516 each may include the name of the product ordered, the quantity, the price, and other information associated with the item ordered (e.g., brand of drink, color of clothing item, size of concession item, etc.). In some examples, edit buttons 1518 and 1520 may enable a user to navigate to a screen to edit an order (e.g., change the quantity or type). In some examples, remove buttons 1526-1528 may enable a user to remove an item from the cart. In some examples, subtotal 1530 may display the subtotal amount for the order from the first store, and subtotal 1532 may display the subtotal amount for the order from the second store. In some examples, order total 1538 may display a total amount for both orders, from the first store and the second store, including the amount of taxes and fees displayed in tax and fee 1536. In other examples, a user may order items from more or fewer stores, and order total 1538 may display a total amount for all of the orders, including the amount of taxes and fees displayed in tax and fee 1536.

In some examples, supply option 1534 may be implemented as a widget, field, pull-down menu, or other method for choosing an option for provision of the ordered items. For example, supply option 1534 may be a pull-down menu with the choices being pick-up or delivery. In some examples, supply option 1534 may indicate a surcharge for an option that may be included in order total 1538 if the option is selected. In some examples, supply location 1540 may indicate the location where the ordered items will be provided. For example, if a user opts for the order to be delivered to a location in a venue (e.g., a seat identified by section, row and seat numbers), supply location 1540 may display that location. In another example, if a user opts to pick up the order, supply location 1540 may indicate the order is to be picked up. In still another example, supply location 1540 may indicate where the order may be picked up. In yet another example, supply location 1540 may indicate a pick up time window.

In some examples, checkout options 1542 and 1544 may be implemented as buttons or links enabling a user to navigate to a screen for checkout. In some examples, checkout option 1542 may link to a screen providing a different payment option than the screen linked by checkout option 1544. For example, different methods of payment may be accepted by the vendor, including credit or debit cards, Paypal®, bank withdrawals, other third-party payment company, or other methods. In this example, checkout option 1542 may be a button or link enabling a user to navigate to a screen for checkout using a third-party payment company (e.g., Paypal®), and checkout option 1544 may be a button or link enabling a user to navigate to a screen for checkout using a credit card. In other examples, payment and supply options for individual stores may be implemented separately (e.g., using separate or separated cart screens for each store). In other examples, a screen displaying selected items and purchase options in a cart may be implemented differently than described herein. In still other examples, a system or application implemented in a location aware mobile marketplace may include more, fewer or different screens (e.g., checkout screen, order success page, etc.).

FIG. 16 illustrates an exemplary computer system suitable for implementation of a location aware mobile marketplace. In some examples, computer system 1600 may be used to implement computer programs, applications, methods, processes, or other software to perform the above-described techniques. Computer system 1600 includes a bus 1602 or other communication mechanism for communicating information, which interconnects subsystems and devices, such as processor 1604, system memory 1606 (e.g., RAM), storage device 1608 (e.g., ROM), disk drive 1610 (e.g., magnetic or optical), communication interface 1612 (e.g., modem, Ethernet card, wireless internet card, etc.), display 1614 (e.g., CRT, LED, LCD, plasma, OLED, etc.), input device 1616 (e.g., keyboard), and cursor control 1618 (e.g., mouse or trackball).

According to some examples, computer system 1600 performs specific operations by processor 1604 executing one or more sequences of one or more instructions stored in system memory 1606. Such instructions may be read into system memory 1606 from another computer readable medium, such as static storage device 1608 or disk drive 1610. In some examples, hard-wired circuitry may be used in place of or in combination with software instructions for implementation.

The term “computer readable medium” refers to any tangible medium that participates in providing instructions to processor 1604 for execution. Such a medium may take many forms, including but not limited to, non-volatile media and volatile media. Non-volatile media includes, for example, optical or magnetic disks, such as disk drive 1610. Volatile media includes dynamic memory, such as system memory 1606.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM. EPROM, FLASH-EPROM, any other memory chip or cartridge, or any other medium from which a computer can read.

Instructions may further be transmitted or received using a transmission medium. The term “transmission medium” may include any tangible or intangible medium that is capable of storing, encoding or carrying instructions for execution by the machine, and includes digital or analog communications signals or other intangible medium to facilitate communication of such instructions. Transmission media includes coaxial cables, copper wire, and fiber optics, including wires that comprise bus 1602 for transmitting a computer data signal.

In some examples, execution of the sequences of instructions may be performed by a single computer system 1600. According to some examples, two or more computer systems 1600 coupled by communication link 1620 (e.g., LAN, PSTN, or wireless network) may perform the sequence of instructions in coordination with one another. Computer system 1600 may transmit and receive messages, data, and instructions, including program, i.e., application code, through communication link 1620 and communication interface 1612. Received program code may be executed by processor 1604 as it is received, and/or stored in disk drive 1610, or other non-volatile storage for later execution.

Although the foregoing examples have been described in some detail for purposes of clarity of understanding, the invention is not limited to the details provided. There are many alternative ways of implementing the invention. The disclosed examples are illustrative and not restrictive.

What is claimed:

1. A method, comprising:
obtaining a location of a client using location data retrieved from the client;
receiving a request from the client, the request associated with one or more items, each of the one or more items being associated with a venue and identified in a database;
determining if the one or more items are available to be provided in response to the request; and
fulfilling the request after determining that the one or more items are available to be provided.

2. The method of claim 1, wherein the request is an order.

3. The method of claim 1, wherein the venue is associated with one or more stores.

4. The method of claim 1, further comprising identifying a store associated with the venue to which the request is directed, the store operable to provide the one or more items.

5. The method of claim 4, further comprising reconciling the request using one or more criteria, the one or more criteria associated with the store.

6. The method of claim 5, wherein the one or more criteria comprises a time period during which the request may be fulfilled.

7. The method of claim 5, wherein the one or more criteria comprises a geographic limitation within which the request may be fulfilled.

8. The method of claim 5, wherein the one or more criteria comprises a criterion associated with an inventory.

9. The method of claim 1, wherein the database comprises an inventory of the one or more items.

10. The method of claim 1, wherein the client is a mobile communication device.

11. The method of claim 1, wherein the fulfilling the request comprises processing a payment for an order.

12. The method of claim 1, wherein the fulfilling the request comprises providing the one or more items.

13. The method of claim 12, wherein the providing the one or more items comprises delivering the one or more items to a location associated with the location data.

14. The method of claim 1, wherein the database comprises an item category, the item category comprising at least one of the one or more items.

15. A system, comprising:
a database configured to store data associated with a venue, a client, and one or more items associated with the venue: and
a processor configured to obtain a location of the client using location data retrieved from the client, to receive a request from the client, the request associated with one or more items, each of the one or more items being associated with a venue and identified in a database, to determine if the one or more items are available to be provided in response to the request, and to fulfill the request after determining that the one or more items are available to be provided.

16. The system of claim 15, wherein the client is a mobile communication device.

17. The system of claim 15, wherein the venue is associated with one or more stores.

18. The system of claim 15, wherein the processor further is configured to identify a store associated with the venue to which the request is directed, the store operable to provide the one or more items.

19. The system of claim 18, wherein the processor further is configured to reconcile the request using one or more criteria, the one or more criteria associated with the store.

20. A computer readable medium including instructions for performing a method, the method comprising:
obtaining a location of a client using location data retrieved from the client;
receiving a request from the client, the request associated with one or more items, each of the one or more items associated with a venue and being identified in a database;
determining if the one or more items are available to be provided in response to the request; and
fulfilling the request after determining that the one or more items are available to be provided.
